(19) United States
(12) Patent Application Publication
(10) Pub. No.: US 2024/0017995 A1
(43) Pub. Date: Jan. 18, 2024

(54) DIRECT COUPLED ATMOSPHERIC CARBON REDUCTION DEVICE WITH HYDROGEN UTILIZATION

(71) Applicant: Roger Swenson, Salt Lake City, UT (US)

(72) Inventor: Roger Swenson, Salt Lake City, UT (US)

(21) Appl. No.: 18/475,633

(22) Filed: Sep. 27, 2023

Related U.S. Application Data
(63) Continuation-in-part of application No. 17/214,704, filed on Mar. 26, 2021.

(51) Int. Cl. C01B 3/48; C01B 3/38; C01B 3/40

(52) U.S. Cl. CPC C01B 3/48; C01B 3/382; C01B 3/40; C01B 2203/0475; C01B 2203/0485; C01B 2203/86; C01B 2210/0064; C01B 2210/0098; C01B 2203/061

(57) ABSTRACT

Combining multiple subsystems involving biomass processing, biomass gasification of the processed biomass where a synthesis gas is produced then converted to hydrogen fuels or other transportation fuels for use in coupled transportation systems sized to consume all the transportation fuel produced. Carbon in the biomass is converted to CO₂ in the conversion process and a portion of that CO₂ is captured and sequestrated for long term storage as CO₂ or as carbon black.

### BACKGROUND OF THE INVENTION

### Field of the Invention

The present invention relates generally to the field of carbon capture with renewable energy conversion systems. More specifically this invention deals with converting biomass to a useful product hydrogen by using a gasification conversion system producing hydrogen with carbon dioxide capture with sequestration and directing the hydrogen produced into a specialized transportation fuel delivery and use system created to match hydrogen output directly.

### Description of the Related Art

Historically residual biomass use as a fuel has generally been done with direct combustion of biomass to produce heat that is used to produce steam to drive a steam turbine system for power generation. Such systems generally produce power with an efficiency that uses only 20%-25% of the energy available in the biomass. Such systems are generally located in areas where the biomass is readily available such as near lumber mills or other forested areas with substantial biomass availability.

In recent years other systems for converting biomass to usable fuels have been developed such as gasification and pyrolysis-based systems. Gasification systems utilizing biomass in the form of woody residues or municipal waste including bio-solids are available that produce a synthesis gas for use in producing various products at the gasification site. Those products include renewable power from such gas, various gaseous chemicals including methane, liquid fuels such as diesel and gasoline components or even hydrogen alone as a product.

Transportation fuels have been identified as a critical contributor to greenhouse gases that have been increasing and causing negative effects with carbon additions to the atmosphere. Biobased fuels can be used as a transportation fuel to provide lower carbon additions to atmospheric balances of CO₂ given the photosynthetic carbon cycle that they are derived from. That carbon cycle from biofuels can be made to extract CO₂ from the atmosphere if in the process of creating a biofuel product some portion of carbon is extracted from the process and captured in some form and sequestered in long term storage sites. Biomass gasification with the production of hydrogen provides the greatest amount of carbon from the bio-based cycle for capture to storage sites since the product hydrogen, has no carbon remaining. However, the complicated nature of the hydrogen logistics supply chain and specialized utilization systems has made it difficult to deploy hydrogen as a useful product to be used to a substantial degree in transportation.

Conversion of biomass to transportation fuels have various pathways whereby CO₂ can be removed from different processing steps as intermediate chemical compounds are created with less and less carbon content. Such processing steps where CO₂ can be extracted from processes then require a transportation solution and access to a containment system. Such storage systems and large-scale logistics systems for moving CO₂ do not exist in many areas.

Now gasification systems have been engineered at various scales are now available at commercial technology ready levels. Hydrogen production systems from biomass gasification syngas are at commercial technology readiness levels with proven systems. Distribution systems for both liquid and compressed hydrogen are commercially available. Fuel cell electric vehicles (FCEVs) and fuel cell electric trucks (FCETs) are transportation vehicles are now designed and are in small scale production and are looking for mechanisms to reach mass production levels.

The circumstance of a lack of distribution systems with a meaningful supply of hydrogen has been described as a limiting factor in the development and adoption of transportation systems using hydrogen in vehicles such as FCEVs. The lack of operating vehicles that can use hydrogen like FCEVs has been called out as a reason that the distribution systems have not been developed since the economics of installing the production and distribution systems depend on meaningful usage from delivery points. The lack of CO₂ storage sites or logistics to move the extracted CO₂ becomes an inhibiting factor in the development of the hydrogen from biomass with such CO₂ removed. This invention overcomes those constraint issues by bringing the production of hydrogen together simultaneously with a distribution system and a matching use system directly coupled together at the same time and establishing a means to remove carbon without the need for CO₂ logistics and CO₂ storage sites.

### SUMMARY

From the foregoing discussion, it should be apparent that a need exists for a direct coupled atmospheric carbon reduction device with hydrogen utilization. The present invention has been developed in response to the present state of the art, and in particular, in response to the problems and needs in the art that have not yet been fully solved by currently available inventions. Accordingly, the present invention has been developed to provide a mechanism that utilizes carbonaceous materials derived from compounds formed from atmospheric carbon dioxide that has been transformed into biomass material and then transforming that carbonaceous material into hydrogen along with carbon dioxide where the carbon dioxide is captured and sequestered in long term storage or the carbon from the CO₂ is extracted as a solid material to then be stored or used in producing other useful products or even recycled to the gasification system and the hydrogen is used in transportation systems as a fuel.

A method of converting biomass into hydrogen is provided, the steps of the method comprising: creating processed biomass by: adding drying heat to a system configured to reduce moisture of unprocessed biomass to 17% or less by weight; filtering out particulates from the unprocessed biomass which exceed a predetermined diameter threshold using one or more of: a screen, diverter gate, and disc screener, wherein the unprocessed biomass has a moisture content of 30% to 45% by weight; depositing processed biomass in storage; submitting the processed biomass to a gasification process to create a syngas in which: a portion of the processed biomass is converted to carbon dioxide that is captured and sequestered in a storage tank or the biomass carbon from the CO₂ is converted to a solid form of carbon; and hydrogen is produced, captured and directed into a transportation fuel use or for the use in fuel cell vehicles tied into the power grid for power production. The storage tank may be an underground geologic formation.

Ninety-five percent of the processed biomass may be between 2 mm and 80 mm in diameter. In various embodiments, the steps of the method further comprise moving the unprocessed biomass on a moving conveyor belt during the drying step.

The method may further comprise using a plurality of fixed bed reactors in two to five stages to gradually lower outlet temperatures of the processed biomass.

The method may also further comprise subjecting the biomass during gasification to a reaction involving FE-CR-based catalysts.

In various embodiments, the gas inlet temperatures are between 350 degrees and 550 degrees Celsius.

The method may further comprise: submitting compressed syngas to a reactor system in which carbon monoxide in converted into carbon dioxide and water in the presence of steam over a Cobalt/Molybdenum catalyst, removing H2S using an acid gas removal unit; converting carbon monoxide, carbon dioxide and hydrogen into CH4 using a two-pass methanation reactor.

In some embodiments CH4 is produced using carbon dioxide that is produced in the gasification methanation process by introducing hydrogen to the carbon dioxide to produce CH4 and H₂O in a Sabatier reaction. Then the CH4 can be sent to an outlet to transport for hydrogen production elsewhere or the CH4 is sent to a pyrolysis-based decomposition system to decompose the CH4 into carbon black and hydrogen with the carbon black collected and sent to storage or shipped to sites for other useful purposes such as tire manufacturing or for graphite or graphene base product production. The hydrogen introduced to the Sabatier reaction can come from internal sources or external sources with hydrogen produced from low or preferably from zero carbon-based production.

In some embodiments the hydrogen produced from decomposition of CH4 into hydrogen and carbon black is cycled back to the process that reacts hydrogen with CO2 to produce CH4 in order to reduce the amount of hydrogen needed for the reaction with the carbon black collected and sent to storage or shipped to sites for other useful purposes such as tire manufacturing or for graphite or graphene base product production.

In some embodiments, the method further comprises: separating carbon dioxide from a tail gas stream using an amine stripping system; and feeding carbon dioxide gas to an adsorber to react with amine to create a rich amine solution; sending the rich amine solution to a stripper system to desorb the carbon dioxide with heat; releasing and capturing the carbon dioxide into a collection system; cooling desorbed amine and sending it back to adsorber to cycle.

The amine system may remove up to 99.8 of the carbon dioxide.

The method may also further comprise: passing the syngas through a filter system to remove ash; and cleaning tars produced from the syngas using a wash system.

In some embodiments, the unprocessed biomass is: first converted into RNG; and shipped to a site to be converted to hydrogen.

In some embodiments the RNG that is shipped to be converted to hydrogen is converted by way of a pyrolysis decomposition into hydrogen and carbon black and with the carbon black collected and sent to storage or shipped to sites for other useful purposes such as tire manufacturing or for graphite or graphene base product production.

In some embodiments the carbon black that is produced from the conversion of CH4 into components is pelletized and transferred back to the gasification process to reduce the biomass needed by the system.

The method may also comprise a step of delivering the hydrogen to hydrogen-powered vehicles.

The method may further comprise delivering the hydrogen to hydrogen-powered vehicles adapted to deliver unprocessed biomass into storage and/or delivering the hydrogen to hydrogen-powered vehicles adapted to deliver hydrogen into storage.

The method may also comprise a step of delivering the hydrogen to hydrogen-powered vehicles that have been adapted to provide power to a useful purpose.

In some embodiments the hydrogen-powered vehicles used to generate power will be located in a facility that has multiple power connections to accumulate power for delivery at a central facility that is equipped with a vehicle cooling system for use when the vehicles are running in a power generation mode and can provide higher output with fuel cell cooling being provided at the central facility.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a direct coupled atmospheric carbon reduction device with hydrogen utilization in accordance with the present invention;

FIG. 2 illustrates a direct coupled atmospheric carbon reduction device with hydrogen utilization in accordance with the present invention;

FIG. 3 illustrates a direct coupled atmospheric carbon reduction device with hydrogen utilization in accordance with the present invention;

FIG. 4 illustrates a direct coupled atmospheric carbon reduction device with hydrogen utilization in accordance with the present invention;

FIG. 5 is a flow chart of a method of reducing carbon with a direct coupled atmospheric device with hydrogen utilization in accordance with the present invention;

FIG. 6 is a flow chart of a method of reducing carbon with a direct coupled atmospheric device with hydrogen utilization in accordance with the present invention;

FIG. 7 is a flow chart of a method of reducing carbon with a direct coupled atmospheric device with hydrogen utilization in accordance with the present invention;

FIG. 8 is a flow chart of a method of reducing carbon with a direct coupled atmospheric device with hydrogen utilization in accordance with the present invention;

FIG. 9 is a flow chart in accordance with the present invention;

FIG. 10A illustrates a screen for filtering biomass in accordance with the present invention;

FIG. 10B illustrates a screen for filtering biomass in accordance with the present invention;

FIG. 11 illustrates a system and method for gasification to hydrogen in accordance with the present invention;

FIG. 12 illustrates a system and method for gasification to methane for book and claim transfer to a hydrogen production site in accordance with the present invention;

FIG. 13 illustrates a system and method for amine carbon dioxide scrubbing in accordance with the present invention;

FIG. 14 illustrates a system and method for steam reforming in accordance with the present invention;

FIG. 15 illustrates a system and method for converting carbon dioxide from the process into methane and then using some portion of the methane in pyrolysis decomposition step that leaves carbon black and hydrogen as separate outputs in accordance with the present invention;

FIG. 16 illustrates a system and method for converting methane that has been delivered to a hydrogen production site with pyrolysis decomposition system into carbon black and hydrogen as separate outputs in accordance with the present invention;

FIG. 17A illustrates a system and method for converting carbon black into pellets and using those pellets to offset some of the biomass input requirements by using the carbon black pellets as input to the gasification process in accordance with the present invention;

FIG. 17B illustrates a system and method for converting carbon black into pellets and using those pellets to offset some of the biomass input requirements by using the carbon black pellets as input to the gasification process in accordance with the present invention;

FIG. 18 illustrates a system and method 1800 for using hydrogen in accordance with the present invention at a site where multiple fuel cell electric vehicles tied together with a colling system are interconnected to produce power for useful purposes; and

FIG. 19 illustrates an overview of how the pyrolysis decomposition system can be used accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

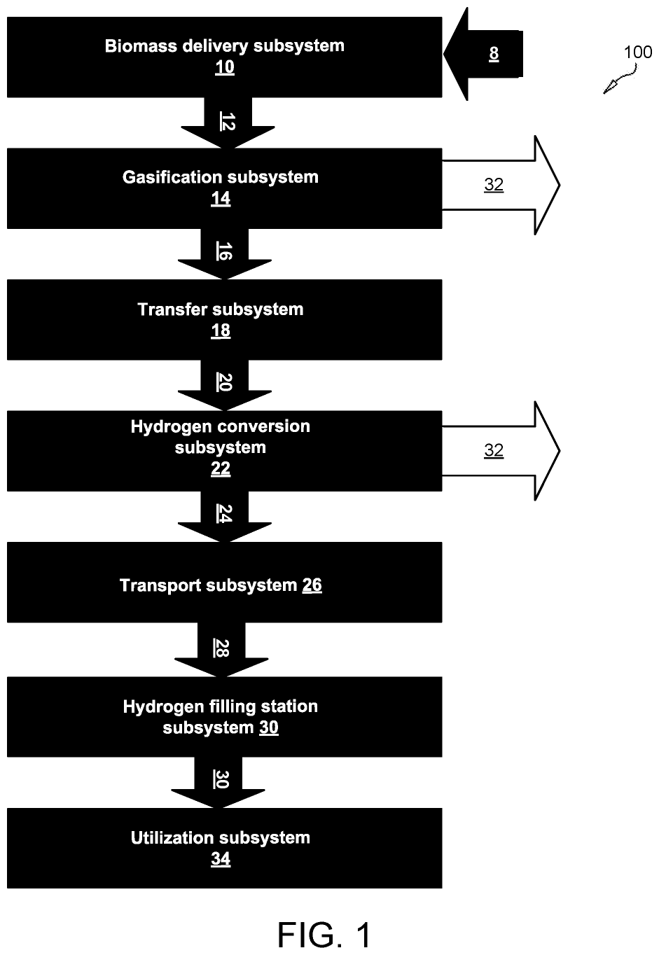

FIG. 1 illustrates a direct coupled atmospheric carbon reduction device with hydrogen utilization 100 in accordance with the present invention.

The system 100 comprises a biomass delivery subsystem 10, a gasification of biomass process subsystem 14, a transfer subsystem 18 adapted to transfer syngas or methane to the hydrogen conversion point; a hydrogen conversion subsystem 20 adapted to deliver to hydrogen buffer storage 204, a transport subsystem 26 adapted to deliver hydrogen to the utilization site, a hydrogen filling station subsystem 30, and utilization subsystem 34.

Biomass 8 is delivered 12 to the gasification subsystem 14. Syngas or methane is transferred 16 to the hydrogen conversion point. The transfer subsystem 18 is adapted to route 20 methane and/or hydrogen to or the hydrogen conversion subsystem 22.

The hydrogen conversion subsystem 22 routes the hydrogen to either the hydrogen buffer storage 204 or to utilization site.

CO₂ 32 is offtaken from gasification subsystem 14 and hydrogen conversion subsystem 22.

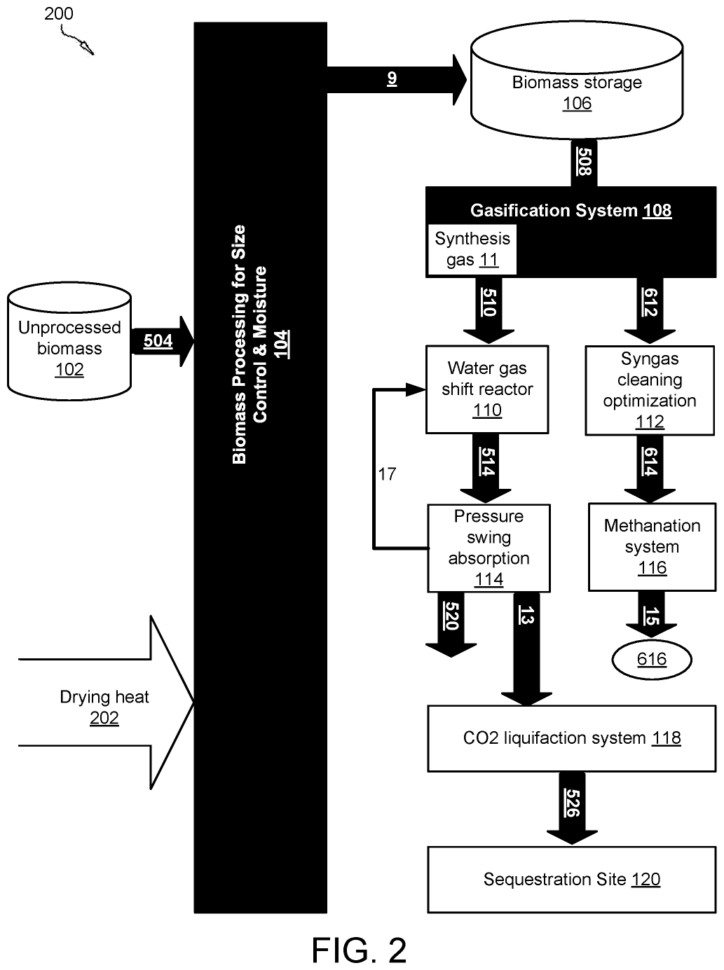

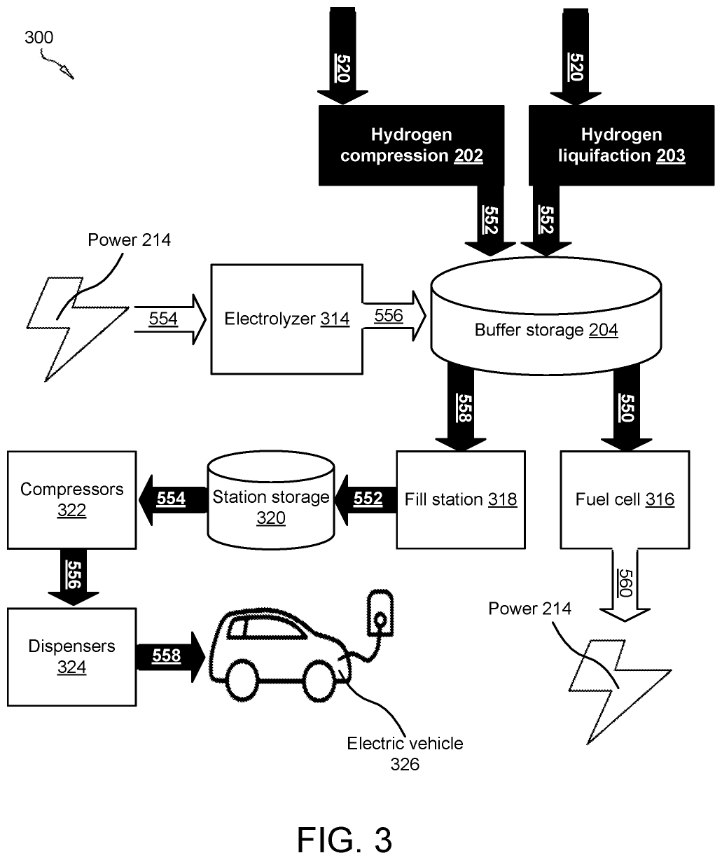

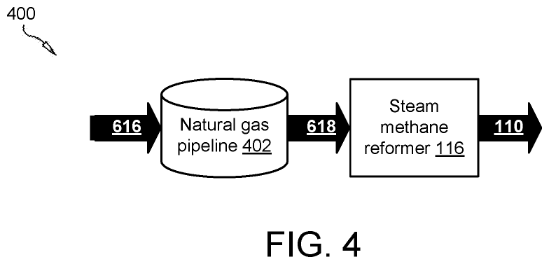

FIGS. 2-4 illustrate a direct coupled atmospheric carbon reduction device with hydrogen utilization 200, 300, 400 in accordance with the present invention.

As shown in system 200, the biomass 8 to be processed in the system 200 is aggregated to a central point 102. Biomass receiving and stockout systems include an area where delivery trucks or barges convey biomass by tipper-type dumpers or by dumping directly into a receipt bin system. Then material from the receipt piles are fed to a conveyor system. The biomass 8 is transferred 504 to a biomass processing system 104 adapted to filter the biomass 8 by size and to measure moisture. Biomass is processed with standard mechanical treatment processes to increase the accessible surface area of the feedstock. Mechanical processing will involve the use of machinery with cutting, chopping or grinding systems for feedstock. Then the material is sent to be screened 902 such that a properly-sized material for input to the gasification system is obtained. A series of diverter gates and disc screeners are used 904 to separate the material to be directed to the appropriate mechanical treatment systems for the received material starting size.

Biomass 8 which falls above or below a predetermined threshold is transferred 506 to biomass storage 106. This threshold may be between 2 mm and 80 mm in average diameter.

Once converted by mechanical means to the appropriate size then the material is sent to a circular or radial stacker for buffer storage material holding. The size requirements for this system is for material to be between 2 mm and 80 mm with a preferred size of the sum of length, height and width less than 100 mm and with 95% of the material above 2 mm in diameter.

The system 104 is adapted to measure moisture content of the input biomass 8 and reduce moisture to a design point preparatory for processing the biomass 8 in the gasification system 108. The processed biomass 9 is then moved to the biomass storage system 106. Input material as received should have a moisture content of 30% to 45% by weight and the preferred moisture content is 30% for as received material.

The processed biomass 9 is moved 508 from the biomass storage 106 to drying system to reduce the moisture content for the gasification system input of 17% moisture by weight or such moisture content that the specific gasification technology provider specifies. Such moisture reduction system may be a conveyer based moving bed dryer using waste heat recovered from the process. The biomass is then fed from a lock hopper system with feed lines to a gasification system 108. Biomass and a bed material are mixed and fed through a biomass metering screw conveyance system where the biomass 9 is processed in the gasification system into a synthesis gas 11. The input materials and super-heated steam are fed into the gasification reactor and are brought to high temperatures by either internal reaction thermal energy with pure oxygen being added or from thermal energy supplied indirectly from an external source. The reaction temperatures vary between reactor designs but generally fall between 600 C and 1000 C depending on target products of syngas 11 for the following process. The syngas 11 is made up of various hydrocarbons comprising predominantly carbon monoxide and hydrogen. This syngas 11 is cleaned by cooling and passing the gas 11 through a filter system to remove unconverted material or ash and then is further cleaned by a tar removal process (or tar removal system 1118). In an indirect gasification system 108, the unconverted carbon and tar is sent to the indirect combustion system to create thermal energy for the gasification drying 906, steaming, and moisture reduction processes. This synthesis gas 11 is either then directed into a system 110 to directly produce hydrogen from the synthesis gas 11 or it is directed into a system 112 to create an intermediate gas product methane.

If the synthesis gas 11 will be converted to hydrogen, the synthesis gas 11 is directed to a water gas shift reactor 110 where the hydrocarbon elements in the synthesis gas 11 are converted to a higher percentage of hydrogen. This reaction lowers the carbon monoxide content in the syngas and increases the hydrogen content by utilizing hydrogen in water or H2O. The process uses one or more fixed bed reactors in 2-3 stages at gradually lower outlet temperatures. FE-CR based catalysts are used in the reaction. Gas inlet temperatures operate between 350 degrees C. and 550 degrees C. That gas is then directed 514 to a pressure swing adsorption (PSA) system 114 where hydrogen is separated from the synthesis gas 11 to provide a concentrated hydrogen stream 13. The PSA process is based on the physical binding property of the gases to a solid adsorbent material remaining in the syngas. The PSA process is a process for separating gas components and is widely used in commercial applications. The feed gas is fed into the adsorber vessels. The vessels are regenerated by lowering the pressure and flushing with a high-pressure product. The low-pressure product containing the contaminant stream is fed back to the water gas system. The tail gas from the PSA is directed back to the water gas shift reactor 110 to continue making hydrogen rich gas and will be cycled through the PSA system.

If the synthesis gas 11 is to be converted to methane, the synthesis gas 11 is first directed 612 to a synthesis gas cleaning and tar removal optimization system 112 to prepare the synthesis gas 11 to be sent to a methanation system 116. Compressed syngas is sent to a reactor system where CO (carbon monoxide) is converted into CO₂ and H₂O in the presence of steam over a Cobalt/Molybdenum catalyst. After that shift reactor process H₂S is removed in an acid gas removal unit. H₂S must be removed because it can deactivate the catalyst the methanation catalyst. The CO, CO₂ and H₂ gases are converted into CH4 in a two-pass methanation reactor. The product leaving the methanation reactor is directed to a molecular sieve and silica gel bed prior to the pipeline system and compressor required to inject the methane into the natural gas pipeline infrastructure 115 that produces a methane rich stream 15 that is suitable to be injected into a natural gas pipeline system 402. The tail gas stream will contain CO₂ and that CO₂ can be separated out by means of an amine stripping system. CO₂ rich gas is fed to an adsorber where the CO₂ gas in the stream reacts with amine. The rich amine solution that is loaded with CO₂ is sent to a stripper system to desorb the CO₂ with heat applied and the CO₂ is released and captured into a collection system. Desorbed amine leaves the system and is cooled and sent back to the adsorber to cycle. Amine systems should be able to scrub the CO₂ stream with up to 40% CO₂ with up to 99.8% removal of the CO₂.

That methane rich stream 15 is then moved physically, or by book and claim transport accounting, to a point where it is removed from a natural gas pipeline 402. Natural gas from the interstate pipeline system is treated to remove and sulfur and chlorine in the feed gas. The clean gas is mixed with process steam and is sent to an adiabatic reformer to convert light hydrocarbons in the natural gas (C2+) before being sent to the primary reformer. That gas is then directed 618 into a steam methane reformer system 116. The syngas produced from the natural gas will then contain CO₂, CO, H₂ and residual CH4. The syngas that is converted from the natural gas to a synthesis gas 11 is taken into a high temperature water gas shift reactor where CO is and input H₂O is converted to H₂ with a residual of 2.5% to 3% CO by volume 110 to produce a hydrogen rich gas (12). That gas is taken to a pressure swing absorption system 114 to provide a concentrated hydrogen stream 13 (i.e., “hydrogen gas”). The PSA unit will separate out 85% to 90% of the H₂ with a purity of 99.9% that is recovered. The tail gas 17 from the PSA may be directed back to the water gas shift reactor 110 to continue making hydrogen rich gas. CO₂ can be separated out from the PSA tail gas that has been stripped of the hydrogen by means of an amine stripping system. CO₂ rich gas is fed to an adsorber where the CO₂ gas in the stream reacts with amine. The rich amine solution that is loaded with CO₂ is sent to a stripper system to desorb the CO₂ with heat applied and the CO₂ is released and captured into a collection system. Desorbed amine leaves the system and is cooled and sent back to the adsorber to cycle. Amine systems should be able to scrub the CO₂ stream with up to 40% CO₂ with up to 99.8% removal of the CO₂.

The hydrogen gas 13 is taken to a hydrogen compression system 202 or a hydrogen liquification system 203 depending on transport need. That hydrogen 13 is then directed 522 into a buffer storage facility 204. The system 202, 203 include a mechanism to balance hydrogen production. If additional hydrogen 13 is needed for the usage systems in this invention, then power 214 will be used to electrolytically produce 556 hydrogen in an electrolyzer 314. If there is a surplus of hydrogen in the buffer 204, then hydrogen will be directed to a fuel cell power production unit 318 to produce power 214. Hydrogen will be directed 558 to the hydrogen transport filling system 318 from the buffer storage 204 as needed.

The hydrogen may be directed into the hydrogen transport system 318. The subsystems shown in FIGS. 2-4 collectively form a pipeline transport system for pure hydrogen, or alternatively a trucking or railroad-based transport system in specialized holding containers for the trucks or rail cars.

The hydrogen fuel is transported 552 to a hydrogen filling stating storage system 320. The hydrogen filling station system 320 transfers the hydrogen through a series of compressors 322 that deliver the hydrogen fuel through dispensers 324 for input to the hydrogen fueled vehicles 326.

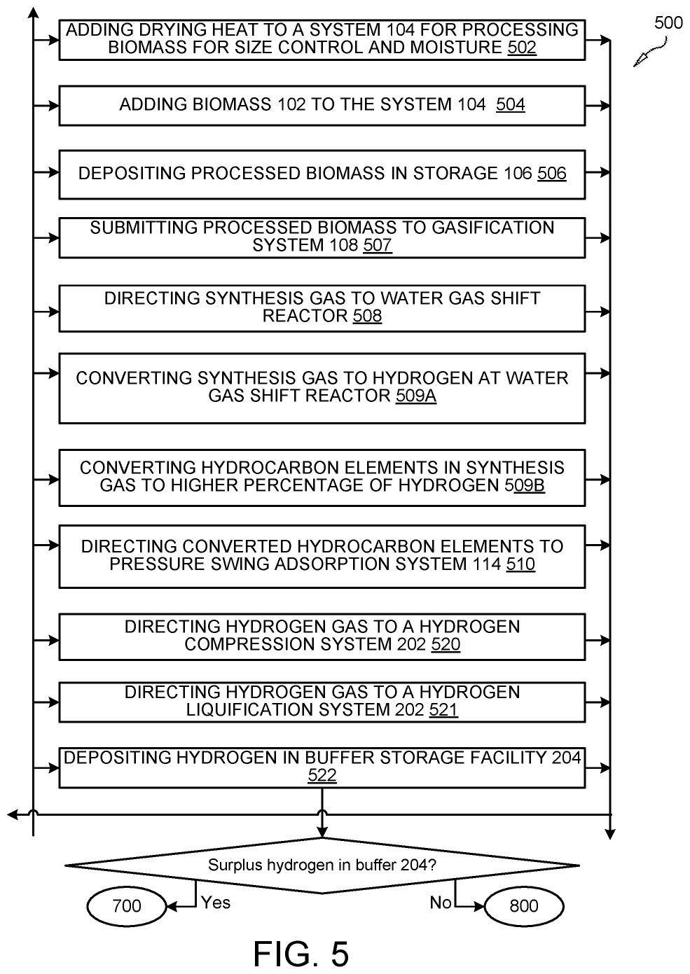

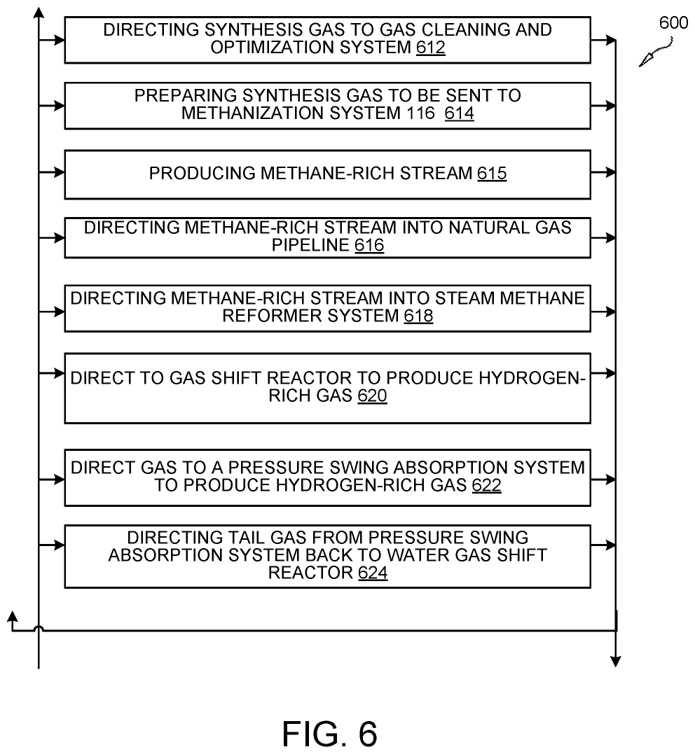

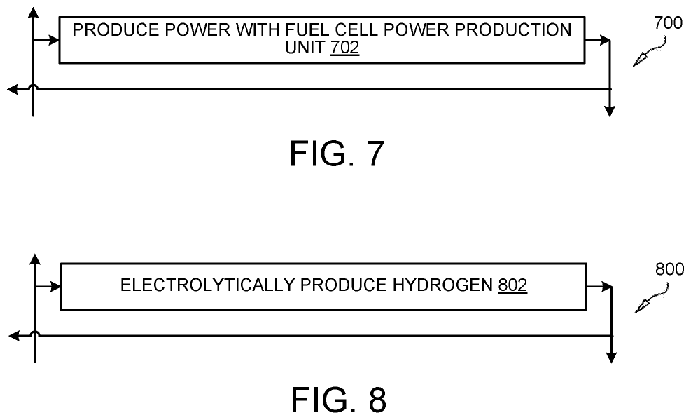

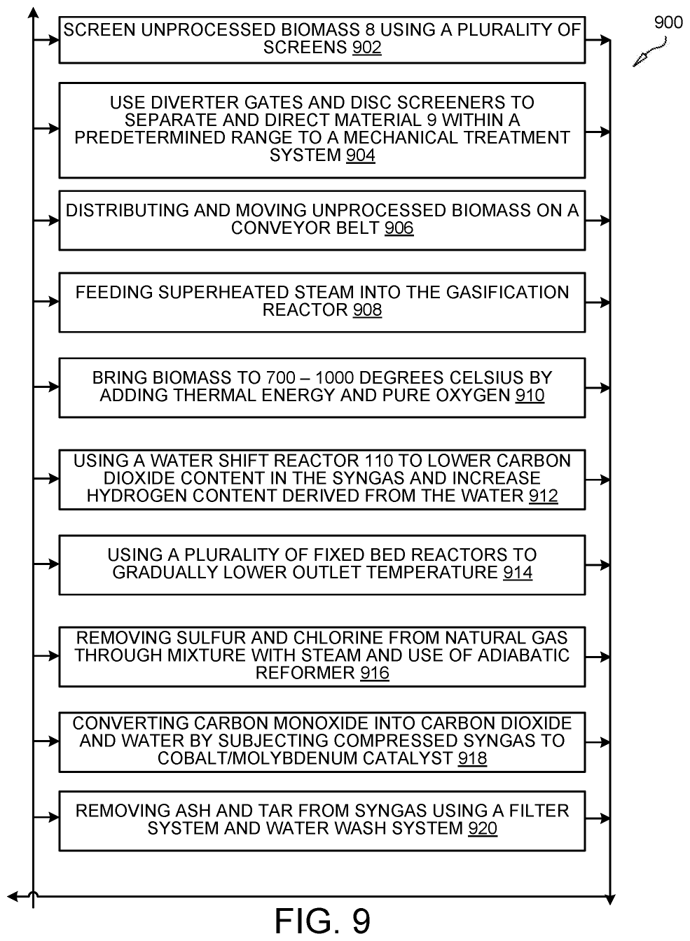

FIGS. 5-9 are flow charts of a method of reducing carbon with a direct coupled atmospheric device with hydrogen utilization in accordance with the present invention.

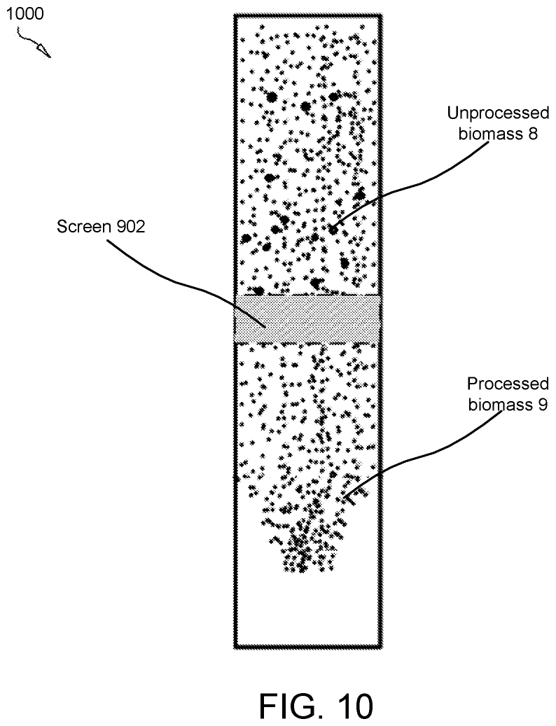

FIGS. 10A-10B illustrates a screen for filtering biomass in accordance with the present invention. Unprocessed biomass is sent to an initial screening system 902 to remove any items such as metal or other unwanted materials.

As shown, the unprocessed biomass 8 is filtered for diameter with a screen 902. In various embodiments, unprocessed biomass 9 is filtered through a 2 mm screen 1054. Particulate of the unprocessed biomass 9 which is less than 2 mm and which passes through the filter is diverted to the 2 mm stockpile 1060. Particulate exceeding 2 mm is directed to an 80 mm screen 1056. Biomass particulate (or material) exceeding 80 mm substantially in width is returned to a sizing system 1064. Particulate passing through the screen 1056 is sent to an 80 mm stockpile 1070.

A mixture of less than 5% of the particulate in the 2 mm stockpile 1060 is sent to a gasification system 108. Approximately 95% of material in the stockpile 1070 is combined with the material from the stockpile 1060 and the combined biomass is sent to gasification 108.

The 2 mm screen 1054 may be between 1.5 mm and 2.4 mm and the 80 mm screen 1056 may between 75 mm and 84 mm.

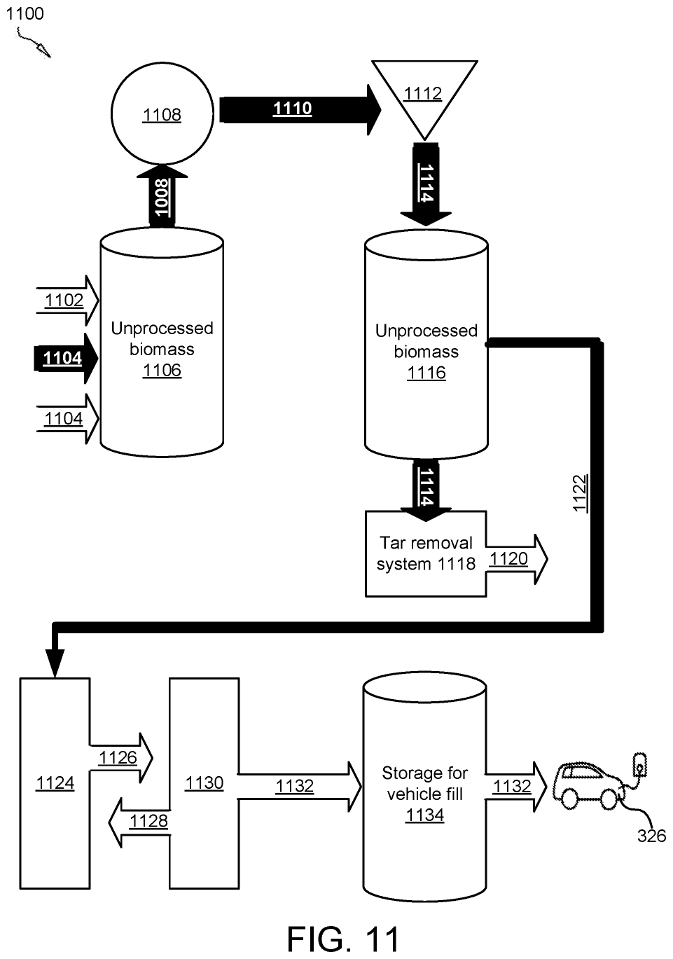

FIG. 11 illustrates a system and method 1100 for gasification to hydrogen in accordance with the present invention.

Steam 1102 and unprocessed biomass 8 (or alternatively, filtered biomass 9 or otherwise processed biomass disclosed above) is input into a gasification system 108 along with one of ambient air 1104 or oxygen (O₂ 1105). Syngas 11 is directed to a syngas cooler 1108. The cooled syngas 1110 is then directed to a gas filter system 1112. Ash and fly coke 1106 are filtered from the system 1112 and diverted to various commercial systems, while the remainder is directed to storage 1116. In some embodiments, the gas is directed in part to a tar removal system 1118 and the tar is sent at 1120 to a combustion system to be used for energy. The syngas portion cleansed of tar may be sent to various commercial system 1122 known to those of skill in the art.

From storage 1116, a water shift reactor 110 is used to upgrade and increase hydrogen content in the input gas 1114 which gas 1126 is then sent to a pressure swing adsorption system (PSA) 114 adapted to concentrate the hydrogen. Tail gases 1128 from the PSA 114 are sent back to the water shift reactor 110. Hydrogen output from the PSA 114 is sent to storage 320 for use, in some embodiments, with fueling hydrogen vehicle 326.

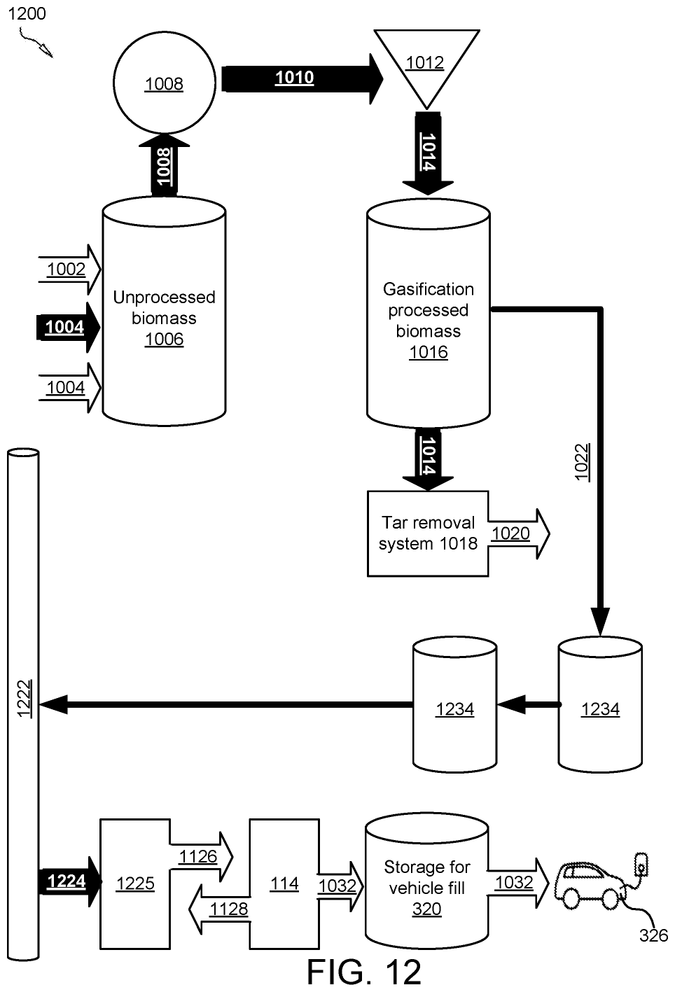

FIG. 12 illustrates a system 1200 and method for gasification to methane for book and claim transfer to a hydrogen production site in accordance with the present invention.

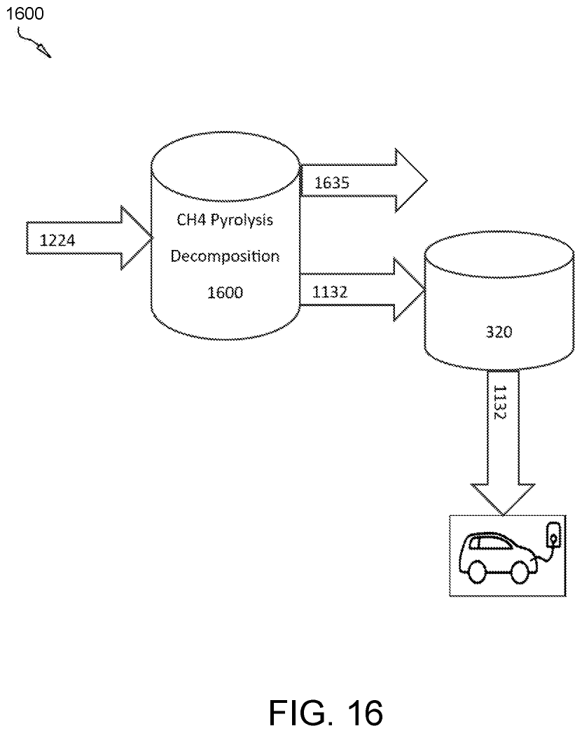

Gas is upgraded 1234 to match the methanation system hydrogen and CO balance required by the methanation system 1236. In various embodiments, methane 1220 is output from a methanation system 1236 to an interstate pipeline 1222 which carries the methane 1222 to a remote location by book and claim transfer. At the remote transfer location, the methane 1224 (in the form of natural gas) is input into a steam methane reformer 1225 or as discussed below and shown in detail in relation to FIG. 16 is decomposed into black and hydrogen. Syngas 11 from the steam methane reformer 1225 is sent to a water shift reactor 110 used to upgrade and increase hydrogen content in the input gas 11 which gas 1126 is then sent to a pressure swing adsorption system (PSA) 114 adapted to concentrate the hydrogen. Tail gases 1128 from the PSA 114 are sent back to the water shift reactor 110. Hydrogen output from the PSA 114 is sent to storage 320 for use, in some embodiments, with fueling hydrogen vehicle 326.

Various methods to decompose or crack hydrocarbons such as methane into carbon black and hydrogen have been under development for over 30 years. The use of thermal plasma technology was started in 1989 by the Norwegian company Kvaerner together with the SINTEF company. A SINTEF-invented graphite plasma torch was used to supply electric heat to the process. Thermal catalytic splitting of methane at temperatures around 1000 C in molten metal and salt baths is a technology that has been investigated for a long time. Today, nickel-bismuth is the preferred alloy, as it can convert 90 to 95% of methane to hydrogen and solid carbon. The challenges of this technology include the separation of carbon products from the metal bath and the qualities of hydrogen and carbon products. A coalition of European companies including the Dutch research organization TNO is working on splitting methane in molten metal baths using a micro-bubbling technic, reducing reaction time and reactor volume and a molten salts concept for the effective separation of the carbon from the bath.

Kvaerner built a commercial scale plant in Montreal, Canada that started operations in 1998. The plant was closed down in 2002 for reasons including financial issues as well as problems related to difficulties in producing the right carbon black qualities for the market (Myklebust, 2020). The US-based company Monolith Materials bought the rights in 2013 and further developed the Kvaerner/SINTEF technology. Monolith has now constructed a plant in Hallam, Nebraska that is now under commercial operation. Various other methane decomposition routes are under development now by companies such as HiiROC in the UK and Torrent in the United States as well as others.

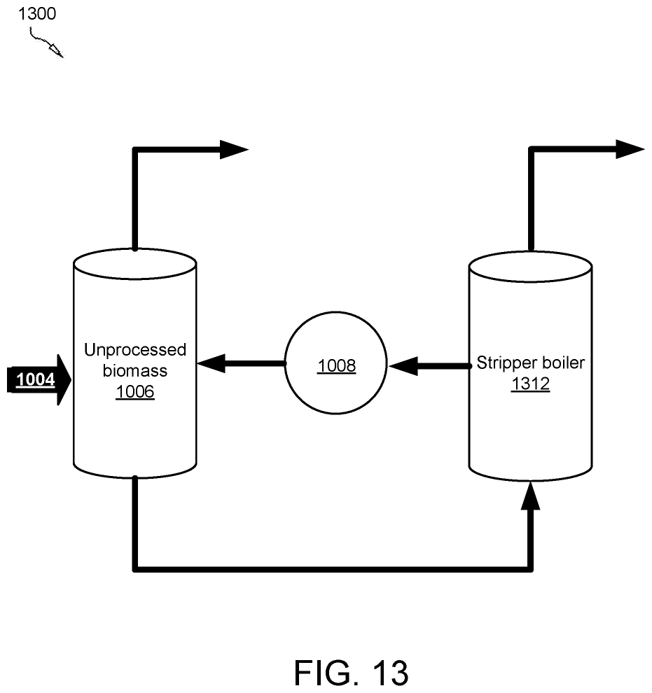

FIG. 13 illustrates a system and method for amine carbon dioxide scrubbing in accordance with the present invention.

In various embodiments, CO₂ is input into a vessel 1304 containing CO₂ absorbing material 1305 as known to those of skill in the art. Lean gases 1318, containing low CO₂, are output from the vessel 1304, while gas 1110 from a syngas cooler 1108 are input. CO₂ bound to amine material is sent to a stripper boiler 1312 where heat is applied and CO₂ gas is collected at 1320. The amine material is then sent to a cooler 1108 to be delivered back into the vessel 1304 at the transfer 1110 input to the amine cycle CO₂ removal system.

Gases from a stripper boiler 1312, which output CO₂ syngas 1320 to divert CO₂ to a storage system.

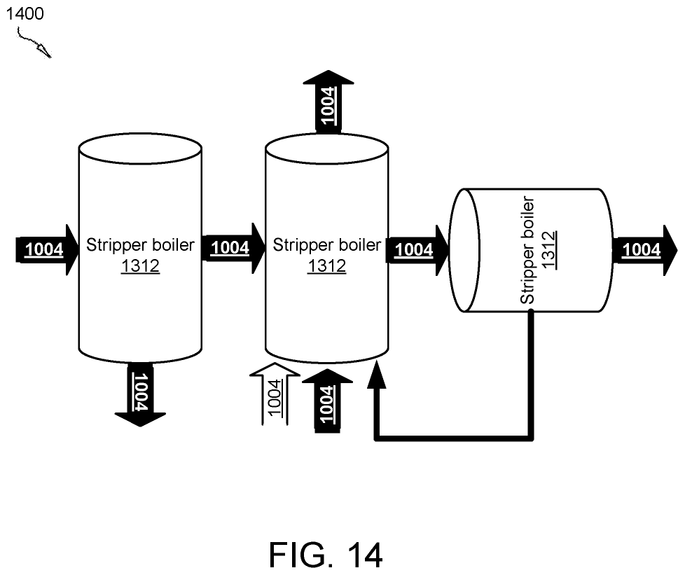

FIG. 14 illustrates a system and method for steam reforming in accordance with the present invention.

In some embodiments, gas 1220 from an interstate pipeline is input into a desulfurization system 1304, wherein sulfur 1406 is diverted therefrom and the remaining methane 1408 (CH4) sent to a reformer reactor 1412.

Steam 1102 from a heat recovery system 1420 is input into the reformer reactor 1412 along with fuel 1414 and tail gas 1128. Gases 1422 from the heat recovery system 1420 are diverted to a water gas shift reactor 110.

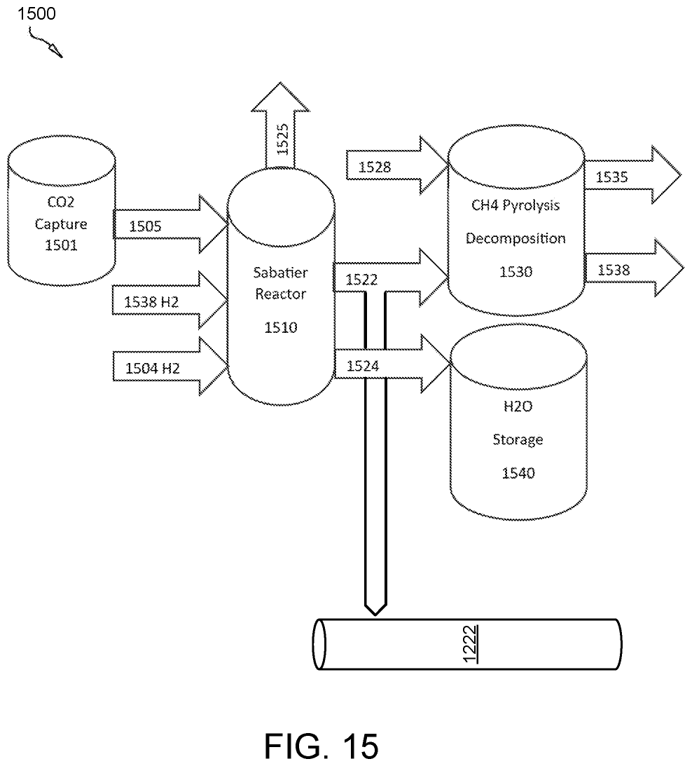

FIG. 15 illustrates a system and method 1500 of capturing carbon dioxide from the process and converting that carbon dioxide into carbon black in accordance with the present invention.

In some embodiments, carbon dioxide gas is captured from various outlets in the gasification 108 and methanation process 116 and directed into a system 1501 to be delivered into a reactor 1510. Hydrogen is also delivered from 1538 into the reactor system along with other hydrogen as needed from outside sources 1504 to have a stochiometric balance to produce methane in the reactor system or for economic reasons. The reactor system will produce methane and water as products and as the process is exothermic heat is also produced that can be directed to produce power needed by the gasification process.

In some embodiments, the methane produced 1522 is directed into a pyrolysis decomposition system 1530 in order to decompose the methane into hydrogen and carbon black material. Other methane may be introduced 1528 (or withdrawn for delivery into a natural gas pipeline system 1022) in order to balance the need for output hydrogen 1538 that is cycled back to the Sabatier reactor 1510 or for economic reasons based on value of methane. Carbon black can be removed and taken to storage or put to use in various products such as tires or graphite-based products or for other uses. Water is also produced as a by-product of the Sabatier reaction 1510 and is taken out 1524 and delivered into a storage facility 1540 for use in various systems.

FIG. 16 illustrates a system and method of capturing carbon 1600 that would be converted from methane in a pyrolysis decomposition process that produces hydrogen and carbon black for producing hydrogen needed in accordance with the present invention.

In some embodiments renewable natural gas produced from gasification 108 and methanation 116 has been directed into a pipeline system for delivery to a hydrogen production facility 1224. That methane can be directed into a pyrolysis decomposition system 1600 to be decomposed into carbon black 1635 and hydrogen 1132. The hydrogen can be taken into the delivery manifold system 320 for delivery into fuel cell electric vehicles 1132.

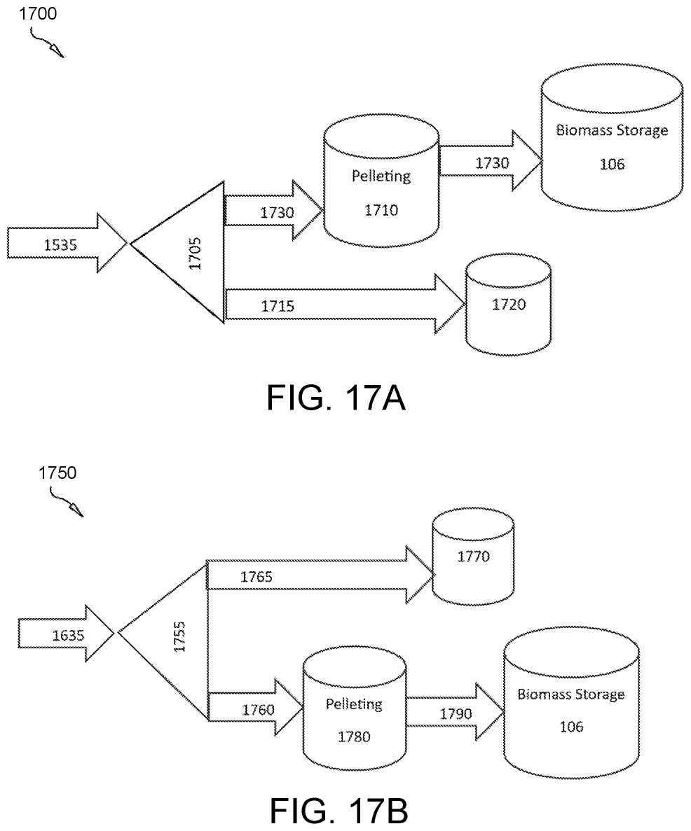

FIG. 17A and FIG. 17B illustrate a system and a method 1700, 1750 for using the carbon black material as an input material for the gasification system creating a carbon use cycle in accordance with the present invention.

In FIG. 17A the carbon black material from input 1535 can be classified 1705 for separation of material that may have a high value for specific carbon products 1715 and those that have a lower value 1730. The lower value carbon black material 1730 can have a binding agent added such that the material can be pressed into pellets 1710 that can be directed to gasification input stockpile 106. The higher value carbon black material 1715 will be shipped to storage for higher value carbon product 1720.

In FIG. 17B the carbon black material from input 1635 can be classified for separation of material 1755 that may have a high value for specific carbon products 1765 and those that have a lower value 1760. The lower value carbon black material 1760 can have a binding agent added such that the material can be pressed into pellets 1780 that can be directed 1790 to gasification input stockpile 106. The higher value carbon black material 1765 will be shipped to storage for higher value carbon product 1770.

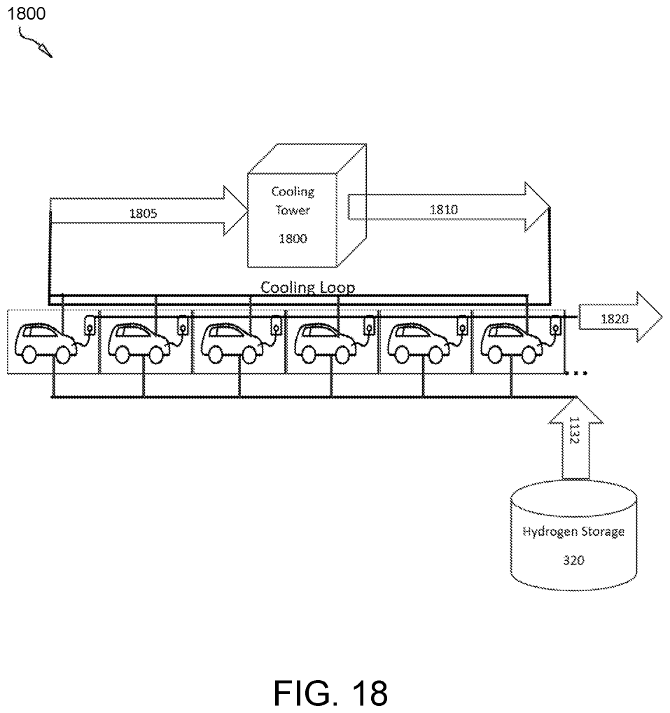

FIG. 18 illustrates a system and a method 1800 for using hydrogen in fuel cell electric vehicles in accordance with the present invention by aggregating many fuel cell electric vehicles to combine their output to achieve larger system output in accordance with the present invention.

In FIG. 18 hydrogen is provided through a manifold system from 320 a storage system and directed into the system in 1132 to maintain a fueling capacity much greater than the fuel cell vehicle hydrogen tank capacity. The power output is delivered through a connection microgrid as shown with 1820 to the power outlet delivery point. The cooling function helps provide an operating condition to achieve a higher output delivery by keep the fuel cell operating conditions within operating temperature range for maximum output using a cooling loop with high temperatures extracted in system 1805 to delivery to the cooling system 1800 and then cool fluid being delivered to the systems in 1810.

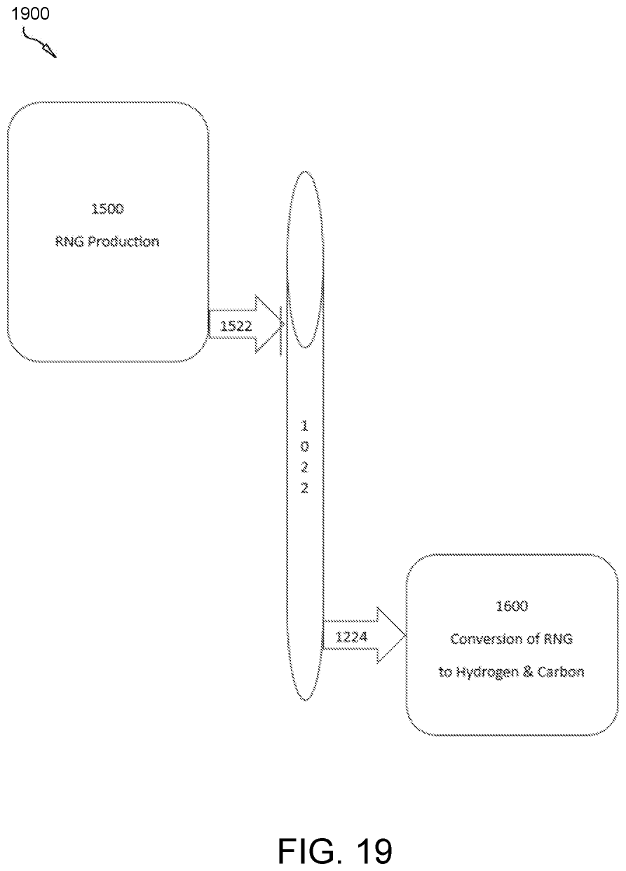

FIG. 19 illustrates an overview of how the pyrolysis decomposition system 1900 can be used in accordance with the present invention in two distinct parts of the invention in section 1500 and in section 1600.

In method 1500 the pyrolysis system the pyrolysis decomposition occurs at a location in the invention where biomass gasification is occurring, and a CO₂ stream is captured that can be upgraded to CH4 with the addition of hydrogen. Then the CH4 is decomposed into carbon and hydrogen.

In method 1600 the pyrolysis decomposition occurs in a location in the invention where CH4 that has been produced and transported by pipeline 1022 to such location is decomposed into carbon and hydrogen for use in fueling fuel cell electric vehicles or stored for such use.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of converting biomass into hydrogen, the steps of the method comprising:
creating processed biomass from unprocessed biomass having a moisture content of 30% to 45% by weight by:
adding drying heat to a system configured to reduce moisture of unprocessed biomass to 17% or less by weight;
filtering out particulates from the unprocessed biomass which exceed a predetermined diameter threshold using one or more of: a screen, diverter gate, and disc screener;
depositing processed biomass in storage;
submitting the processed biomass to a gasification process to create a syngas in which:
a portion of the processed biomass is converted to carbon dioxide that is captured and sequestered in a storage tank; and
hydrogen is produced, captured and directed into a transportation fuel use.

2. The method of converting biomass into hydrogen of claim 1, wherein 95% of the processed biomass is between 2 mm and 80 mm in diameter.

3. The method of converting biomass into hydrogen of claim 1, further comprising moving the unprocessed biomass on a moving conveyor belt during the drying step.

4. The method of converting biomass into hydrogen of claim 1, further comprising subjecting the biomass during gasification to hydrogen a reaction step involving FE-CR-based catalysts.

5. The method of converting biomass into hydrogen of claim 1, further comprising using a plurality of fixed bed reactors processing syngas in two to five stages to gradually lower outlet temperatures of the processed biomass syngas.

6. The method of converting biomass into hydrogen of claim 1, wherein the syngas inlet temperature to a water gas shift reactor is between 350 degrees and 550 degrees Celsius.

7. The method of converting biomass into hydrogen of claim 1, further comprising:
submitting compressed syngas to a reactor system in which carbon monoxide in converted into carbon dioxide and water in the presence of steam over a Cobalt/Molybdenum catalyst,
removing H₂S and CO₂ using an acid gas removal unit;
converting carbon monoxide, carbon dioxide and hydrogen into CH4 using a two-pass methanation reactor.

8. The method of converting biomass into hydrogen of claim 1, further comprising:
separating carbon dioxide from a tail gas stream using an amine stripping system; and
feeding carbon dioxide gas to an adsorber to react with amine to create a rich amine solution;
sending the rich amine solution to a stripper system to desorb the carbon dioxide with heat;
releasing and capturing the carbon dioxide into a collection system;
cooling desorbed amine and sending it back to adsorber to cycle.

9. The method of converting biomass into hydrogen of claim 8, wherein the amine system removes up to 99.8 of the carbon dioxide.

10. The method of converting biomass into hydrogen of claim 1, further comprising:
passing the syngas through a filter system to remove ash; and
cleaning the syngas using a wash system and removing tar.

11. The method of converting biomass into hydrogen of claim 1, wherein the unprocessed biomass is:
first converted into RNG; and
shipped or transferred by book and claim methods to a site to be converted to hydrogen.

12. The method of converting biomass into hydrogen of claim 1, further comprising delivering the hydrogen to hydrogen-powered vehicles.

13. The method of converting biomass into hydrogen of claim 1, further comprising delivering the hydrogen to hydrogen-powered vehicles adapted to deliver unprocessed biomass into storage.

14. The method of converting biomass into hydrogen of claim 1, further comprising delivering the hydrogen to hydrogen-powered vehicles adapted to deliver hydrogen into storage.

15. The method of converting biomass into hydrogen of claim 1, further comprising delivering the hydrogen to a plurality of hydrogen-powered vehicles adapted to deliver power to the electric grid as required.

16. The method of converting biomass into hydrogen of claim 7, further comprising decomposing the RNG into hydrogen and carbon black.

17. The method of converting biomass into hydrogen of claim 16, further comprising a recycling of said hydrogen to a CO2 plus hydrogen reactor to produce additional CH4.

18. The method of converting biomass into hydrogen of claim 15, further F comprising a plurality of hydrogen-powered vehicles adapted to deliver power at a central facility equipped with a cooling system to allow the adapted hydrogen-powered vehicles to operate with a higher output of electric power, wherein said electric power is directed to an inverter and subsequently connected to a microgrid for use.

19. The method of converting biomass into hydrogen of claim 15, further comprising directing electric power to an electric transformer system to increase the power to a voltage suitable for delivery to an electric utility grid system.
